(19) United States
(12) Patent Application Publication
(10) Pub. No.: US 2016/0056691 A1
(43) Pub. Date: Feb. 25, 2016

(54) SELF-CENTERING FOR ENCODER DEVICE

(71) Applicant: NIDEC AVTRON AUTOMATION CORPORATION, INDEPENDENCE, OH (US)

(72) Inventor: Eric B. Hale, Cleveland, OH (US)

(21) Appl. No.: 14/466,348

(22) Filed: Aug. 22, 2014

(51) Int. Cl. H02K 11/00; H02K 7/08

(52) U.S. Cl. CPC H02K 11/0015; H02K 7/085

(57) ABSTRACT

A self-centering device for a motor having a base and a shaft extending through the base and rotatable relative to the base along an axis includes a housing having a flange for securing the housing to the motor base. A bushing is connected to the housing and has a passage for receiving the motor shaft. A rotary encoder is secured to the housing and configured to measure at least one of position or rotation of the motor shaft. Positioning the motor shaft in the passage in the bushing centers the housing on the motor shaft to place the encoder in a desired position for measuring the at least one of position or rotation of the motor shaft.

### TECHNICAL FIELD

This disclosure relates generally to motors and, more specifically, relates to a self-centering device for an encoder.

### BACKGROUND

Encoders are used in motor applications to monitor the rotation of a shaft transmitting power through the system. Modular encoders in use today currently use either pre-existing pilot holes on a motor (or generator) face to center the encoder on the motor shaft or hollow clamping shafts with internal bearings and tethering devices. Pre-existing pilot holes, however, may be absent and/or not in their intended position, which can compromise installation accuracy and reliability. Hollow clamping shafts are expensive to manufacture and are prone to installation errors and bearing failure.

### SUMMARY

One example provides a self-centering device for a motor having a base and a shaft extending through the base and rotatable relative to the base along an axis includes a housing having a flange for securing the housing to the motor base. A bushing is connected to the housing and has a passage for receiving the motor shaft. A rotary encoder is secured to the housing and configured to measure at least one of position or rotation of the motor shaft. Positioning the motor shaft in the passage in the bushing centers the housing on the motor shaft to place the encoder in a desired position for measuring the at least one of position or rotation of the motor shaft.

Another example provides a system that includes a housing having an interior space and a flange for securing the housing to a base of an apparatus from which a rotatable shaft extends. A retaining plate can be secured to the housing within the interior space and include an opening. A bushing is positioned between the housing and the retaining plate such that a distal end portion of the bushing extends through the opening in the retaining plate. The bushing also includes a passage at its distal end portion for slidably receiving the shaft therein. An encoder is configured to measure at least one of angular position or rotation of the shaft. The encoder includes at least one sensor connected to the housing for measuring the at least one of angular position or rotation of the shaft. In response to the shaft being received in the passage of the bushing, the housing aligns with respect to the shaft to place the at least one sensor within a predetermined radial distance from a longitudinal axis of the shaft.

A self-centering device for a motor having a base and a shaft extending through the base and being rotatable relative to the base along an axis includes a housing having an interior space and a flange for securing the housing to the motor base. A retaining plate having an opening is secured to the housing within the interior space. A bushing extends through the opening in the retaining plate and is positioned between the housing and the retaining plate. The bushing has a passage for slidably receiving the motor shaft. An encoder for measuring motor shaft rotation has a shaft component fixed to the motor shaft and at least one sensor connected to the housing for measuring rotation of the shaft component. Positioning the motor shaft in the passage in the bushing centers the housing on the motor shaft to place the at least one sensor in communication with the shaft component for measuring rotation of the motor shaft.

Yet another example provides a method that includes providing a device housing that includes an interior space. The housing includes a bushing and encoder electronics mounted within the interior space of the housing. The bushing includes a passage configured to receive a rotating shaft that extends axially from a base of a rotary apparatus. The encoder electronics are spaced apart from bushing. The housing also includes a flange extending outwardly from an end of the housing. The method also includes receiving the motor shaft in the passage of the bushing to position the encoder electronics within a predetermined distance with respect to the axis of the shaft to enable the encoder electronics to measure at least one of motion or position of the rotatable shaft. The flange of the housing can be secured to the base of the rotary apparatus.

### BRIEF DESCRIPTION OF THE DRAWINGS

FIG. 1 is a schematic illustration of an example of a self-centering device secured to a motor.

FIG. 2 is an exploded assembly view of FIG. 1.

FIG. 3A is an isometric view of a housing of the self-centering device of FIG. 1.

FIG. 3B is a bottom view of the housing of FIG. 3A.

FIG. 4A is an isometric view of a centering bearing of the self-centering device of FIG. 1.

FIG. 4B is a sectional view of the centering bearing of FIG. 4A taken along line 4B-4B.

FIG. 5A is an isometric view of a hollow shaft component of the self-centering device of FIG. 1.

FIG. 5B is a sectional view of the hollow shaft component of FIG. 5A taken along line 5B-5B.

FIG. 5C is a top view of the hollow shaft component of FIG. 5A.

FIG. 6 is a schematic illustration of an encoder of the self-centering device of FIG. 1.

FIG. 7 is a sectional view of the self-centering device and motor of FIG. 1 taken along line 7-7.

### DETAILED DESCRIPTION

This disclosure relates generally to encoders and, more specifically, relates to a self-centering device for measuring angular position and/or rotation of a rotating shaft. The device includes a housing (e.g., a stator housing) that includes a bushing and an encoder. The bushing can be mounted in a predetermined position and include a passage configured to receive a rotatable shaft (e.g., of a motor or generator) therein. The passage of the bushing has a central axis that has a predetermined spatial relationship with a sensor of the encoder. The encoder can be implemented as an absolute or incremental rotary encoder. When the shaft is received within the bushing 116 of the housing, the bushing operates as a mechanical template to align the housing with respect to the shaft such that the encoder is positioned at a desired position and orientation to measure the position and/or rotation of the shaft. For example, the encoder can include a sensor configured to sense indicia on a rotor that is secured to the shaft and received within the housing for sensing by the sensor. The bushing thus operates to self-align a central axis (e.g., centerline) of the rotor with a corresponding axis (e.g., centerline) of the encoder sensor to enable the sensor to measure position and/or motion of the rotor affixed to the shaft. Accordingly, once the shaft is received in the bushing, the housing can be fixed to a surface from which the shaft extends (e.g., by bolts or other fastener means). Once the housing is fixed to the surface, the bushing permits the substantially free rotation of the shaft in a non-interfering manner such that it could be removed without affecting operation of the encoder.

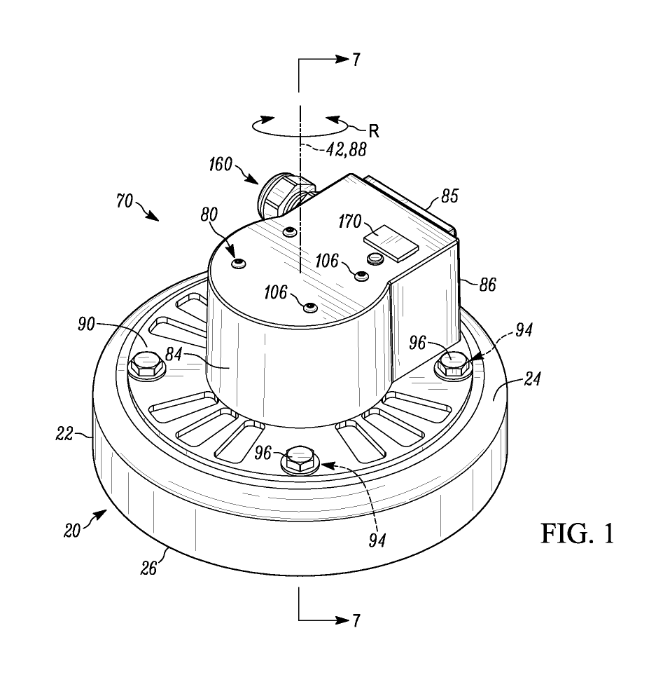

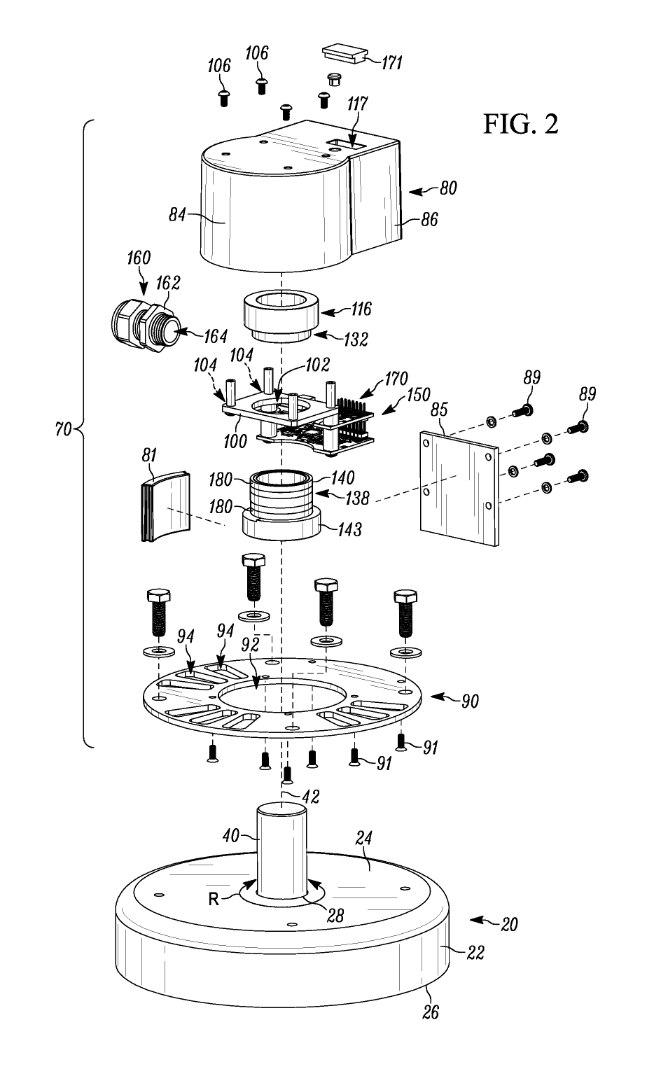

FIGS. 1 and 2 illustrate examples of a self-centering device 70. The device 70 can used to precisely position an encoder apparatus with respect to a rotating shaft, such as a rotor shaft of a motor or generator, to help accurately track angular position and/or rotation of the shaft. In one example, the device 70 includes a housing 80, a bushing 116 positioned in the housing and configured to provide for self-centering the device with respect to a shaft 40 of an apparatus 20, such as for a motor, generator or other rotating shaft carrying apparatus. The device can also include an encoder 150 mounted in the housing and configured to measure angular position and/or rotation of the shaft.

As one example, the apparatus 20 constitutes a typical electric motor for generating and transmitting torque in a system. The apparatus 20 includes a base 22 having a generally cylindrical shape that defines a pair of opposing end faces or surfaces 24, 26. A cylindrical passage 28 extends though the base 22 between the end surfaces 24, 26. A cylindrical rotor shaft 40 extends along an axis 42 through the passage 28. The shaft 40 is rotatable about the axis 42 relative to the base 22 in the direction indicated generally by the arrow R. The passage 28 can contain motive generating structures, which can vary depending on the type and configuration of the apparatus 20.

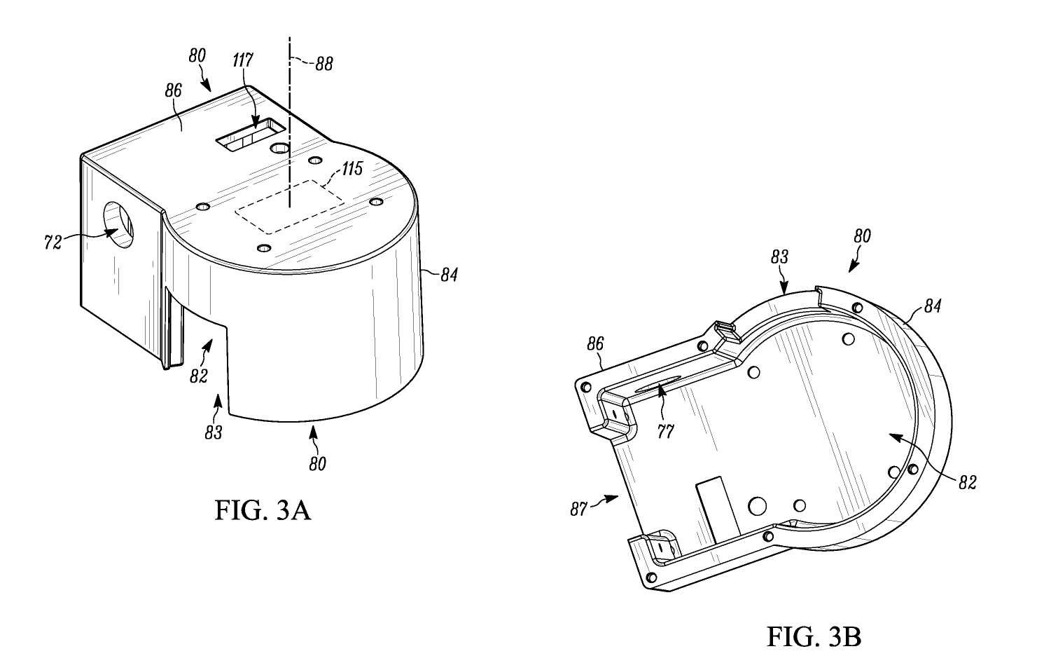

Referring to FIGS. 3A-3B, the housing 80 includes a first portion 84 and a second portion 86 that cooperate to define an interior space 82. The first portion 84 can have a generally circular shape centered on an axis 88. The second portion 86 extends from the first portion 84 in a direction extending radially outward from the axis 88. The second portion 86 may have a square or rectangular shape, for example. A lateral opening 83 extends through the first portion 84 to the interior space 82. The lateral opening 83 can be closed by a removable door or plate 81 (see FIG. 1) secured to the first portion 84. An additional opening, shown in phantom at 115, may extend through the top of the first portion 84 into the interior space 82. An opening 117 extends through the top of the second portion 86 into the interior space 82. A pair of lateral openings 77, 87 extends through the side of the second portion 86 to the interior space 82. The lateral opening 87 is closed by a removable door or plate 85 secured to the second portion 86 via fasteners 89 (see FIG. 1). The housing 80 can be made of a substantially rigid material, such as a metal (e.g., stainless steel, aluminum or the like) or it can be made from a non-metal material such as a polymer or plastic.

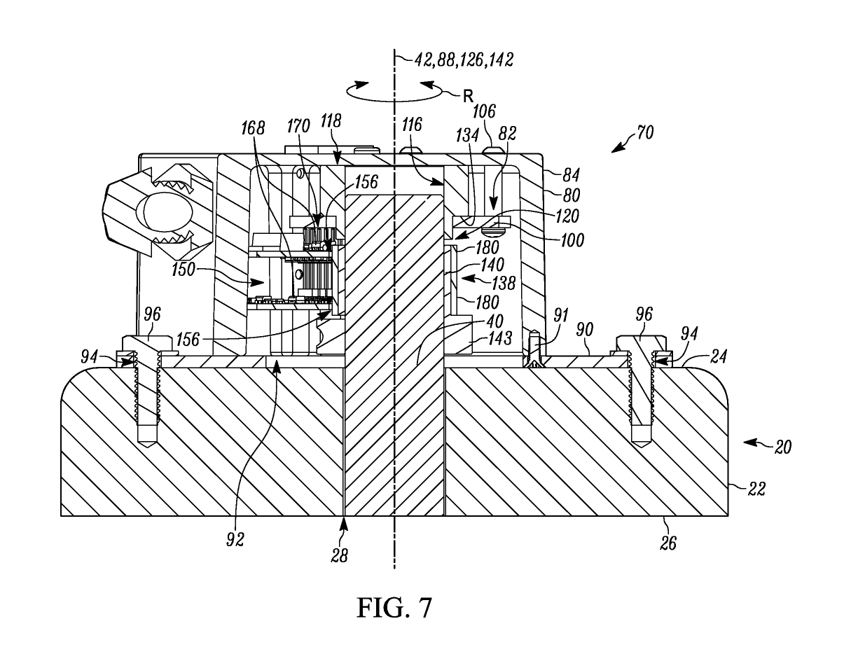

Referring to FIGS. 2 and 7, the housing includes a flange 90 that can be connected to the first portion 84 and the second portion 86 to partially close the interior space 82 of the device 70. The flange 90 may be a separate component secured to the housing 80 via fasteners 91 (as shown) or, in other examples, may be integrally formed with the housing. The flange 90 may therefore be made from the same material as the housing 80 or from a different material than the housing, e.g., metal or plastic. In any case, the flange 90 extends radially outward from the first portion 84 of the housing 80. As illustrated, the flange 90 can be a continuous annular flange and can be generally concentric with the first portion. In other examples, the flange can be configured as one or more radially outwardly extending features that is configured to secure the housing to a surface of the apparatus 20 as the bushing 116 within the housing aligns sensing circuitry with respect to the shaft. In the example of FIGS. 2 and 7, a central opening 92 extends through the flange 90 and is centered about the axis 88 of the first portion 84 to provide access to the interior contents of the device 70 (e.g., containing the bushing and encoder sensing circuitry). Optionally, one or more outer openings 94 extend through the flange 90 and are positioned circumferentially about the central opening 92. The openings 94 can be pre-configured or be customized for a particular installation, such as to align axially with threaded boreholes in the apparatus 20 for securing the flange to the apparatus via threading fasteners 96 in such boreholes. In some examples, the threaded boreholes can be formed in the surface of the apparatus 20 during installation of the device 70 to the apparatus 20.

Referring to FIG. 2, a retaining plate 100 is provided to be connected to the first portion 84 of the housing 80 within the interior space 82. The retaining plate 100 can be rectangular or another shape and includes a central opening 102 and a plurality of outer openings 104 positioned radially outward from the central opening. The openings 104 are dimensioned and configured to receive fasteners 106 for securing the retaining plate 100 to the first portion 84 of the housing 80. The retaining plate 100 may be formed from metal or plastic. The central opening is dimensioned and configured to provide for passage of a distal end of the bushing 116 therethrough while the retaining plate clamps the bushing at a predetermined position between the retaining plate and the first portion of the housing 84. By clamping the bushing 116 between the retaining plate and the housing in this manner, the bushing can be considered held by a weak friction fit sufficient to perform its self-alignment function while also being free or floatable within the housing.

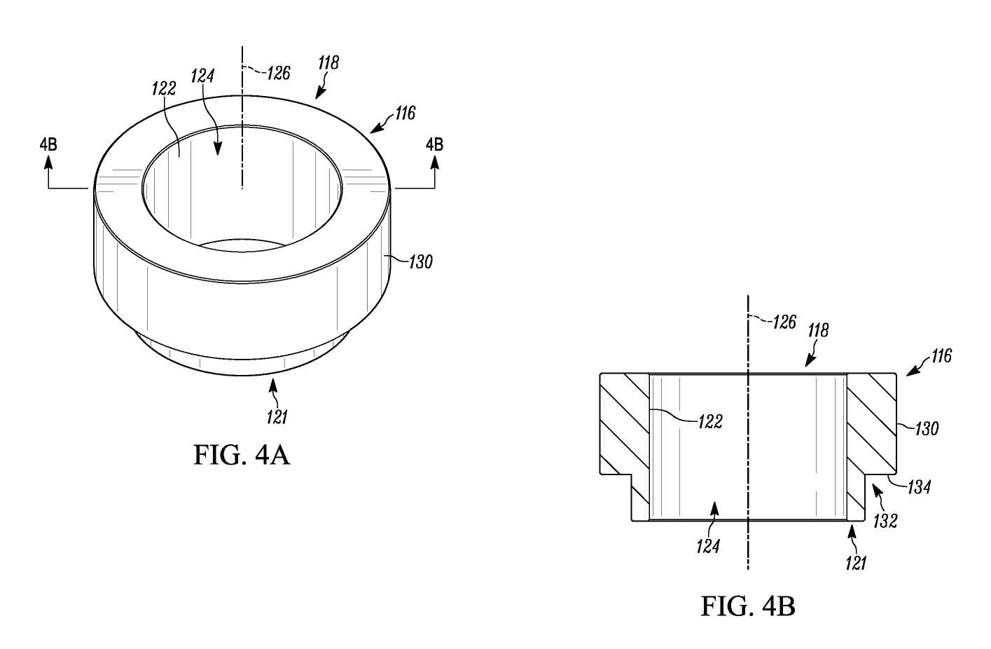

Referring to the example of FIGS. 4A and 4B, the centering bushing 116 is ring-shaped and extends along an axis 126 from a first end 118 to a second end 121. The bushing 116 includes an inner surface 122 defining a cylindrical passage 124 extending along the axis 126 entirely through the bushing 116. The inner diameter of the passage 124 is sized to be slightly smaller (e.g., 1-10 microns larger) than the diameter of the shaft 40 to ensure a precise fit between the bushing 116 and shaft. In one example, the passage 124 and shaft 40 form a tight, sliding fit with one another to enable rotation of the shaft relative to the bushing (e.g., due to wearability and/or lubricant impregnated with the material forming the sidewall of the passage).

The bushing 116 includes a peripheral surface 130 extending circumferentially about the axis 126. A recess 132 is formed in the peripheral surface 130 and extends from the second end 121 towards the first end 118, terminating at an end surface 134 between the first and second ends. The recess 132 is concentric with the inner surface 122. The recess 132 can provide a shoulder that is engaged by (e.g., provide an abutment with) an adjacent surface of the retaining plate 100 for clamping the bushing with respect to the housing while the end 121 protrudes through the opening in the retaining plate for receiving the shaft 40.

The bushing 116 can be made from a wearable material, such as a metal, plastic or polymer, which may be lubricated or unlubricated. In one example, the bushing 116 is made from bronze, e.g., SAE 841 oil-impregnated, sintered bronze. In another example, the bushing 116 may be made from a plastic or polymer impregnated with oil or another lubricant. The bushing 116 may be molded and/or machined to accommodate a variety of different shaft diameters.

Referring back to FIG. 2, the encoder 150 constitutes an encoder 150 that cooperates with a hollow shaft component (e.g., a rotor) 138 to measure angular position and/or rotation of the shaft 40. It will be understood that the shaft component 138 may alternatively constitute part of the encoder 150. In any case, the encoder 150 may constitute any one of a number of known encoder types. For example, the encoder 150 may be mechanical, optical, magnetic, inductive or capacitive.

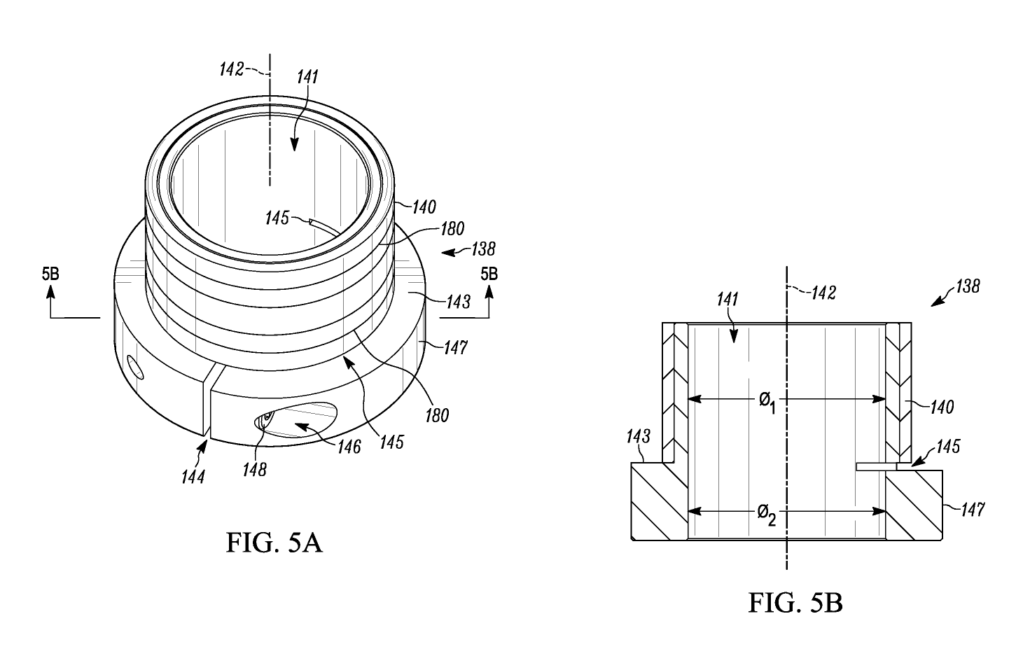

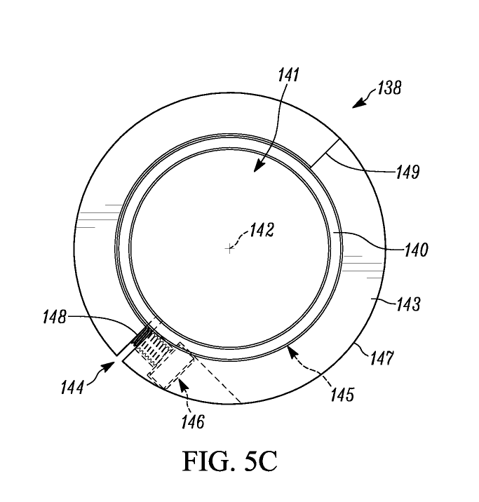

Referring to example demonstrated in FIGS. 5A-5C, the shaft component 138 is provided as a rotor that is to be secured to the shaft 40 of the apparatus 20 and, in turn, rotate with the shaft. The shaft component 138 includes a ring-shaped base 140 and a clamping member 143 extending radially outward from the base. Indicia 180 can be disposed about the base for sensing by the encoder 150. In this example, the indicia 180 are demonstrated as including one or more bands that extend around the outer periphery of the base 140. The indicia 180 may be formed from a series of discrete markings or other detectable objects, which can vary depending on the type of encoder technology being implemented (e.g., magnetic, optical, inductive, capacitive, etc.). The indicia 180 can vary along the circumference to encode angular position and/or rotation information for the shaft 40. In some examples, the indicia 180 may be formed from one or more strips of material different from the rest of the base 140.

By way of further example, a passage 141 extends entirely through the shaft component 138 along an axis 142. The passage 141 has a circular cross-section sized to slidably receive the shaft 40 of the apparatus 20. The passage 141 has a first diameter Φ₁ within the base 140 and a second diameter Φ₂ within the clamping member 143. The clamping member 143 includes an outer peripheral surface 147. A slot or passage 144 extends from the outer surface 147, through the clamping member 143, and into the passage 141. As a result, the clamping member 143 has a C-shaped axial cross-section. An annular slot or passage 145 extends from the passage 144 and circumferentially about the axis 142. The annular passage 145 extends entirely through the clamping member 143 such that the clamping member and base 140 are spaced apart from one another along the annular passage 145. Due to the passages 144, 145, a portion of the clamping member 143 is movable relative to the base 140 and movable relative to the remainder of the clamping member. In other words, the portion of the clamping member 143 along the annular passage 145—and spaced from the base 140—is movable relative to the base as well as the portion of the clamping member secured directly to the base.

A lateral passage 146 extends through the outer surface 147 of the clamping member 143 to the annular passage 145. A fastener 148 extends through the lateral passage 146 and the annular passage 145. The fastener 148 threads into the clamping member 143 such that the degree of threaded engagement between the fastener and clamping member adjusts the circumferential width of the annular passage 144. In other words, rotating the fastener 148 moves the portion of the clamping member 143 along the annular passage 145 relative to the portion of the clamping member secured directly to the base 140 as well as the base. As a result, the diameter Φ₂ of the passage 141 within the clamping member 143 may be reduced to a size that is equal to or smaller than the diameter Φ₁ to secure the shaft component 138 to the shaft 40 of the apparatus 20.

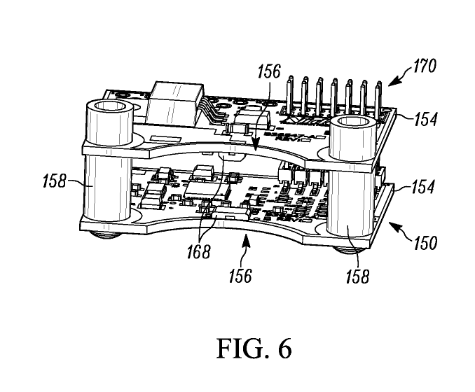

As shown in FIG. 6, the encoder 150 includes one or more circuit boards 154 secured together by fasteners 158. Each circuit board 154 includes electronic components for detecting, measuring, and transmitting information related to rotation of the shaft 40. Each circuit board 156 can include an arcuate recess 156 that mimics the outer contour of the base 140 of the shaft component 138. One or more sensors 168 can be provided on each circuit board 156 for detecting rotational movement of the bands 180 on the shaft component 138. The sensor 168 may be an optical sensor, magnetic sensor, etc., which can depend on the type of encoder technology being implemented. A programming port 170 can be electrically connected to the circuit boards 154, which allows the user to program, calibrate, test or otherwise adjust sensing variables programmed into the circuit boards and/or sensors 168. In other examples, the data can be transmitted wirelessly (e.g., via Bluetooth, WiFi or another short range wireless technology). A door or panel 171 is releasably secured to the first portion 84 of the housing 80 and extends through the opening 117 in the housing (see FIG. 3A) and provides access to the programming port 170 when the device 70 is installed.

Referring to FIGS. 1 and 2, an adapter 160 is configured to be secured to the second portion 86 of the housing 80 and extend through the lateral opening 77 in the second portion into the interior space 82. The adaptor 160 includes a fastener 162 and a passage 164 extending through the fastener to receive wires (not shown) for the transmission of data from the encoder 150 to a controller (not shown). The adaptor 160 can be electrically connected to the controller (not shown) and relays data related to the shaft 40 rotation to the controller.

Referring to FIGS. 2 and 7, when the device 70 is assembled, the second end 121 of the bushing 116 extends through the central opening 102 in the retaining plate 100. This places the end surface 134 in abutment with the retaining plate 100. Although the retaining plate 100 and bushing 116 are shown as separate components it will be appreciated that the retaining ring and bushing could be formed as a single, integrated component (not shown). Regardless of the construction, in this configuration, the central opening 102 in the retaining plate 100 can center the axis 126 of the bushing 116 in predetermined orientation and position. The fasteners 106 extend through the outer openings 104 in the retaining plate 100 and secure the retaining plate to the first portion 84 of the housing 80 within the interior space 82. This positions the bushing 116 within the interior space 82 between the first portion 84 of the housing 80 and the retaining plate 100, with the axis of the bushing in a predetermined position. In one example, the bushing 116 is not fastened to either the retaining plate 100 or the housing 80. Rather, the bushing 116 is clamped or held between the retaining plate 100 and the housing 80 to prevent relative axial movement between the bushing and the retaining plate or housing. Alternatively, the retaining plate 100 and housing 80 may be spaced from one another sufficient to allow some movement of the bushing 116 along the axis 126 between the retaining plate and housing (not shown), such as after the housing has been secured to the apparatus 20. In other words, in another example, the bushing 116 may be axially moveable relative to the retaining plate 100 over a portion or all of the depth of the recess 132.

In some examples, the first portion 84 of the housing 80 may be configured to prevent removal of the bushing 116 from between the retaining plate 100 and housing once the fasteners 106 are secured. In other examples, the first portion 84 may include a removable door or other structure, e.g., the phantom door 115 in FIG. 3A, that allows the bushing 116 to be removed from between the retaining plate 100 and the housing 80 after the device has been secured to the apparatus 20 in a desired position and orientation.

The encoder 150 is secured via the fasteners 158 to the retaining plate 100 within the interior space 82 of the housing 80. This suspends the encoder 150 from the retaining plate 100. At this point, a chuck or other alignment tool (not shown) may be used before tightening the fasteners to ensure the bushing 116 is properly positioned relative to the housing 80 and sensors 168, i.e., the axis of the bushing is properly aligned to provide the axis 88 of the housing 80. The chuck may be cylindrical and may be positioned abutting the arcuate recesses 156 in the circuit boards while abutting the retaining plate 100 and encircling the bushing 116. This centers the bushing 116 along the axis 88 of the housing 80 and precisely locates the bushing relative to the sensors 168 on the circuit boards 154. The fasteners 106, 158 are then tightly secured and the chuck removed.

The adaptor 160 can be inserted through the opening 77 in the second portion 86 of the housing 80 into the interior space 82. This places the passage 164 of the fastener 162 in fluid communication with the interior space 82. The fastener 162 secures the adaptor 160 to the second portion 86. The door 171 is positioned in the opening 117 in the housing 80. Wires can be electrically connected to the circuit boards 154 and fed through the passage 164 in the adaptor 160 to be electrically connected to the controller (not shown). Alternatively, the adaptor 160 may be omitted and data from the circuit boards 154 sent wirelessly to a controller or other remote circuitry (not shown).

The shaft component 138 is positioned over the shaft 40 of the apparatus 20 such that the shaft extends through the passage and the clamping member 143 is spaced axially from the end surface 24 of the motor. The shaft 40 extends first through the clamping member 143 then through the base 140. The fastener 148 is tightened to draw the portions of the clamping member 143 together to reduce the diameter Φ₂ until the clamping member clamps around the shaft 40, thereby fixing the shaft component 138 to the shaft. Subsequent rotation of the shaft 40 in the direction R therefore rotates the shaft component 138 in the direction R. Alternatively, the shaft component 138 may be omitted entirely and the indicia (e.g., bands) 180 formed or provided directly on the shaft 40 (not shown).

At this time, if a pre-existing pilot exists in the end surface 24 of the base 22 (e.g., an annular recess in the surface of the motor base), one or more ring-shaped covering members (not shown) resembling the flange 90 may be placed on the end surface to cover or fill the pilot. The shaft 40 and shaft component 138 pass through the covering and freely rotate relative thereto. The covering member thus can be positioned between the flange 90 and the surface 24 of the base of the apparatus 20 prior to attaching the housing to such surface. The covering member thus can be utilized to effectively eliminate the recessed portion corresponding to the pilot such that originally intended alignment function of the pilot is removed. In other examples, the flange itself can be configured to have an outer diameter dimensioned to fit within the pilot, such that the alignment or misalignment afforded by the existing pilot can be eliminated.

In any case, the assembled device 70 is then brought near the apparatus 20 and the device oriented such that the central opening 92 in the flange 90 faces the end surface 24 of the motor and, where present, the ring-shaped covering. The user then aligns the axes 42 of the shaft 40 with the axis 126 of the passage 124 in the bushing 116 and moves the bushing—with the housing 80 and encoder 150 secured thereto—onto the shaft. During this movement, the shaft 40 and shaft component 138 pass through the central opening 92 in the flange 90 and the central opening 102 in the retaining plate 100 until the shaft extends into the passage 124 in the bushing 116. The shaft 40 can move into and through the passage 124 until the flange 90 abuts the end surface 24 of the base 22. In this configuration, the device 70 is substantially free to rotate about the shaft 40 relative to the base 22 in the direction R, which allows the device 70 to be moved to a desirable circumferential position about the axis 42, e.g., to align the passage 164 in the adaptor 160 of the encoder 150 with connecting wiring and/or position the second portion 86 of the housing 80 out of the way of other structures. Regardless of the orientation of the device 70, the encoder 150 is positioned such that the arcuate recesses 156 in the circuit boards 154 are adjacent and substantially concentric to the periphery of the base 140 of the shaft component 138. In this orientation, the sensors 168 are positioned adjacent to and radially aligned with the bands 180 on the shaft component 138.

Since the retaining plate 100 is securely fastened to the housing 80, the central opening 102 in the retaining plate helps maintain the passage 124 of the bushing 116 disposed therein coaxial with the axis 88 of the housing. Furthermore, the recess 132 in the bushing 116 cooperates with the retaining plate 100 to prevent the axes from 88, 126 from misaligning. Consequently, when the shaft 40 is positioned within the passage 124 of the bushing 116, the bushing precisely and repeatably aligns the axis 42 of the shaft with the axis 88 of the housing 80. As a result, the sensors 168 on the circuit boards 154 of the encoder 150, which are also securely fastened to the housing 80, are precisely radially aligned with the indicia 180 on the shaft component 138 regardless of the rotational orientation of the device 70 relative to the apparatus 20. This precise positioning of the circuit boards 154 relative to the shaft component 138 allows the sensors 168 to detect rotation of bands 180, which corresponds with the rotation of the shaft 40 secured thereto. The bushing 116 can facilitate and enable precisely aligning the axis 88 of the housing 80 with the axis 42 of the shaft 40, therefore positions and fixes sensing circuitry of the encoder 150 at a predetermined distance from the rotating shaft to ensure the encoder will accurately detect and measure rotation of the shaft.

Once the desired rotational position of the device 70 relative to the shaft 40 is achieved the user secures the flange 90 to the base 22. More specifically, fasteners 96 may be inserted into the openings 94 and threaded into the base 22 to secure the device 70 to the apparatus 20. To this end, the user may drill or otherwise form the openings in the base 22 for receiving the fasteners 96 once the flange 90 abuts the end surface 24. In other words, the openings in the base 22 for receiving the fasteners 96 can be pre-existing openings in the base or can be newly formed during installation of the device 70. The device 70 therefore does not rely on pre-existing openings or pilot holes in the apparatus 20 to be secured to the motor. More particularly, since the bushing is secured with respect to the housing in a predetermined position when it is attached to the shaft, the bushing performs self-alignment function for the housing with respect to the shaft. Accordingly, the modular encoder does not need to rely on the axial and radial position of any pre-formed pilot that may exist in the base 22. Although the flange 90 is shown as including the openings 94 it will be appreciated that these openings may be initially omitted and subsequently formed in the flange once the device 70 is placed on the apparatus 20.

Once the device 70 is secured to the apparatus 20 rotation of the shaft 40 in the direction R about the axis 42 likewise rotates the shaft component 138 in the direction R. As the shaft component 138 rotates the sensors 168 of the encoder 150 track movement of the bands 180 passing thereby and convert that movement into a digital signal to be transmitted through wires (not shown) passing through the adaptor 160 to the controller (not shown) to be processed. Since the device 70 is securely fastened to the apparatus 20 and properly aligned relative to the axis 42 of the shaft 40 by the bushing 116, the encoder 150 may readily and repeatably track shaft rotation.

If the bushing 116 becomes worn over time due to wobbling or misalignment of the shaft 40, the encoder 150 still will function properly despite any such wearing of the bushing. That is, the bushing 116 can be employed to provide for initial alignment and attachment to the base 22, after which the function is minimal. For example, after the housing 80 has been secured to the base 22 according to the alignment afforded by the bushing 116, in some examples, the bushing of the device 70 can be removed. The bushing 116 can be replaced if desired; however, it is not needed for continued operation of the device 70 after it has been attached to the apparatus 20. This is because the functioning of the encoder 150 electronics in sensing the bands 180 does not depend on the bushing 116. Therefore, so long as the encoder 150 is properly functioning, even if the bushing 116 has become worn, it may be moved to a different or event the same apparatus and still afford the self-alignment function to enable operation as an encoder. In any case, the device 70 is configured to ensure that wear of the bushing 116 does not compromise the encoding function after it has be used for the precision centering and securing of the device to the apparatus 20.

As mentioned, the device 70 simplifies securing the housing 80 and apparatus 20 together in that the need to locate and/or rely on pilot holes on the motor or secure a tether between the device and motor are alleviated. Instead, once the flange 90 abuts the end surface 24 of the base 22, the user may simply drill and tap holes anywhere on the flange into the end surface 24 to allow the fasteners 96 to secure the device to the motor. Accordingly, the bushing 116 itself—and not pilot holes or other pre-existing apparatus structure—is used to align the device 70 on the shaft 40 and thereby precisely position the encoder 150 relative to the shaft for sensing angular position and/or motion of the shaft.

The self-aligning construction of the bushing 116 also simplifies assembling of the device 70 on the apparatus 20 and positioning of the encoder 150 relative to the shaft component 138. By merely inserting the motor shaft 40 into the self-aligning/self-centering bushing 116, the sensors 168 of the encoder 150 are automatically aligned with the bands 180 on the shaft component 138 secured to the shaft 40, which ensures accurate and repeatable measuring of the motor shaft rotation. The self-centering device of the disclosed herein therefore reduces costs, improves the accuracy and versatility in installation locations, and increases the overall life expectancy of the product by reducing wear on components that might otherwise be out of tolerance with one another.

What have been described above are examples. It is, of course, not possible to describe every conceivable combination of components or methodologies, but one of ordinary skill in the art will recognize that many further combinations and permutations are possible. Accordingly, the disclosure is intended to embrace all such alterations, modifications, and variations that fall within the scope of this application, including the appended claims. As used herein, the term “includes” means includes but not limited to, the term “including” means including but not limited to. The term “based on” means based at least in part on. Additionally, where the disclosure or claims recite “a,” “an,” “a first,” or “another” element, or the equivalent thereof, it should be interpreted to include one or more than one such element, neither requiring nor excluding two or more such elements.

What is claimed is:

1. A self-centering device for securing to a base through which a rotatable shaft extends along an axis, the self-centering device comprising:
a housing including a flange to secure the housing to the base;
a bushing connected to the housing and having a passage for receiving the rotatable shaft; and
an encoder secured to the housing spaced apart from the bushing, the encoder being configured to measure at least one of position or rotation of the rotatable shaft;
wherein positioning the rotatable shaft in the passage of the bushing aligns the encoder with respect to the rotatable shaft to enable the encoder to measure the at least one of position or rotation of the rotatable shaft.

2. The self-centering device of claim 1, wherein the encoder is one of a magnetic encoder, an optical encoder, an inductive encoder or a capacitive encoder.

3. The self-centering device of claim 2, wherein the encoder further comprises a sensor secured within the housing and a shaft component separate from the housing and fixed to the rotatable shaft such that a portion of the rotatable shaft extends beyond the shaft component and is received in the passage of the bushing, the sensor configured to sense indicia on the shaft component to detect the at least one of position or rotation of the rotatable shaft.

4. The self-centering device of claim 1, wherein the flange extends radially outward from the housing and receives at least one fastener to secure the housing to the base.

5. The self-centering device of claim 1, wherein the bushing comprises a wearable substantially rigid material.

6. The self-centering device of claim 5, wherein the bushing comprises a lubricant-impregnated material.

7. The self-centering device of claim 1, further comprising a retaining plate connected to the housing to clamp the bushing between the retaining plate and the housing to hold the bushing and the passage in a predetermined position and orientation within the housing.

8. The self-centering device of claim 7, wherein the retaining plate includes an opening through which an end of the bushing extends, the bushing having a shoulder spaced apart from the end and abutting the retaining plate adjacent the opening to prevent the bushing from passing entirely through the retaining plate while clamped between the retaining plate and the housing.

9. The self-centering device of claim 1, wherein the passage of the bushing is configured to have an inner diameter that approximates an outer diameter of the rotatable shaft as to facilitate substantially free rotation of the rotatable shaft relative to the bushing.

10. The self-centering device of claim 1, wherein the housing includes an opening for removing the bushing from the housing while the flange of the housing is secured to the base.

11. The self-centering device of claim 1, further comprising a member configured to cover a pre-existing pilot in the base prior to securing the flange to the base.

12. The self-centering device of claim 1, further comprising fasteners extending through the flange into the base to secure the self-centering device to the base.

13. A system, comprising:
a housing having an interior space and a flange to secure the housing to a base of an apparatus from which a rotatable shaft extends;
a retaining plate secured to the housing within the interior space, the retaining plate having an opening;
a bushing positioned between the housing and the retaining plate such that a distal end portion of the bushing extends through the opening in the retaining plate, the bushing including a passage at the distal end portion for slidably receiving the rotatable shaft therein; and
an encoder for measuring at least one of angular position or rotation of the rotatable shaft, the encoder including at least one sensor connected to the housing for measuring the at least one of angular position or rotation of the rotatable shaft;
wherein, in response to receiving the rotatable shaft in the passage of the bushing, the housing aligns with respect to the rotatable shaft to place the at least one sensor within a predetermined distance from a longitudinal axis of the rotatable shaft.

14. The system of claim 13, wherein the apparatus is a motor or a generator having a pilot formed as a recessed portion in a surface of the base of the apparatus from which the rotatable shaft extends, the system further comprising a covering member positioned between the flange and the surface of the base of the apparatus, the covering member filling the recessed portion in the surface covering the pilot.

15. The system of claim 13, further comprising fasteners extending through the flange and into boreholes in the base to secure the housing to the base of the apparatus while the rotatable shaft is positioned in the bushing.

16. The system of claim 13, wherein the flange extends radially outward from the housing and receives at least one fastener to secure the housing to the base.

17. The system of claim 13, wherein the bushing comprises a wearable substantially rigid material, the passage in the bushing is configured to have a diameter that approximates an outer diameter of the rotatable shaft to enable substantially free rotation of the rotatable shaft with respect to the bushing while the housing is secured to the base of the apparatus.

18. The system of claim 17, wherein the substantially rigid material comprises a lubricant impregnated material to facilitate rotation of the rotatable shaft relative to the bushing.

19. The system of claim 13, wherein an outer sidewall of the bushing has a shoulder spaced apart from a distal end of the bushing and abutting the retaining plate adjacent the opening of the retaining plate to prevent the bushing from passing entirely through the retaining plate while clamped between the retaining plate and the housing.

20. A method comprising:
providing a housing that includes an interior space, the housing comprising:
a bushing mounted within the housing, the bushing comprising a passage configured to receive a rotatable shaft that extends axially from a base of a rotary apparatus;
encoder electronics mounted within the interior space and spaced apart from the bushing; and
a flange extending outwardly from an end of the housing;
receiving the rotatable shaft in the passage of the bushing to position the encoder electronics within a predetermined distance with respect to an axis of the rotatable shaft to enable the encoder electronics to measure at least one of motion or position of the rotatable shaft; and
securing the flange of the housing to the base of the rotary apparatus.
